(19) United States
(12) Patent Application Publication
(10) Pub. No.: US 2004/0227329 A1
(43) Pub. Date: Nov. 18, 2004

(54) Baby carriage comprising push arms fitted with rotating handles, and corresponding handle

(75) Inventor: Bruno Zweideck, Cholet (FR)

Correspondence Address: David D. Brush, Westman, Champlin & Kelly, Suite 1600, 900 Second Avenue South, Minneapolis, MN, 55402-3319, US

(73) Assignee: AMPAFRANCE, Cholet (FR)

(21) Appl. No.: 10/779,564

(22) Filed: Feb. 13, 2004

(30) Foreign Application Priority Data
Feb. 17, 2003 (FR) FR 03 01908

(51) Int. Cl. B62B 1/00

(52) U.S. Cl. 280/642

(57) ABSTRACT

A baby carriage has a frame comprising two push arms each fitted with a handle free to pivot. The handle comprising means of locking/unlocking in at least two angular positions with respect to the arm and means of actuating the locking/unlocking means. The actuation means are free to move along an axis approximately perpendicular to the axis of the push arm.

### FIELD OF THE INVENTION

This invention relates to the field of childcare. More precisely, the invention relates to baby carriages and particularly baby carriages fitted with two independent handles.

### BACKGROUND OF THE INVENTION

In the field of baby carriages, a distinction can be made between two major categories of means for guidance by a user; handlebars extending transversely and connecting two side elements of the frame, and independent handles each installed along the prolongation of a side element of the frame.

These independent handles are used particularly in the case of strollers equipped with a frame that can be folded in which the sides of the frame move towards each other (3D fold), to make the folded stroller as compact as possible, to make it easier to store it and, for example, to transport it in an automobile.

In this type of folding, it can be understood that a transverse handlebar would hinder folding (unless it is articulated). Therefore it is advantageous to use an independent handle on each side of the frame.

Therefore, these handles are installed at the end of push arms, and for example the push arms may be extended by the front wheels legs, and be installed free to slide with respect to these wheel legs. Therefore, each handle has the first fastening part fitted in line with the push arm and a second gripping part extending at an angle of the order of 90° (this value being given solely for guidance) from the first part.

For ergonomy and user comfort reasons, and also to reduce the size of the stroller in the folded position, it has been proposed to make each handle free to pivot with respect to the push arm so that the handles can occupy two separate positions: one position in which it extends along the main axis of the stroller, and another position in which it extends perpendicular to this axis (the two handles then facing each other). The user can thus choose the position that he likes best. For obvious safety and comfort reasons, it must be possible to fix the handles in each of the defined positions. Therefore, means of locking/unlocking the handle in position with respect to the corresponding push arm have been proposed, controlled by actuation means.

One example of this type is described in U.K. patent document GB-2,333,269. According to this technique, the actuation means consist of a push button that can be moved parallel to the axis of the push arms. This button entrains locking/unlocking means along a displacement in a direction parallel to the axis of the push arms, like engaging and disengaging a clutch.

The locking/unlocking means consist of a dog clutch system. This type of arrangement requires fairly complicated mechanisms, which are long and difficult to install and are therefore relatively expensive.

Moreover, the position of the control push button is such that it is difficult to actuate it with a single hand while rotating the corresponding handle, this maneuver requiring a twist of the wrist that is not very convenient.

One particular purpose of the invention is to overcome the disadvantages of prior art.

More precisely, the purpose of the invention is to propose a baby carriage with more practical pivoting handles that are simpler to manipulate than handles according to prior art.

In this respect, another purpose of the invention is to supply such a handle for which the actuation means are more easily accessible and more easily handled with one hand than existing handles.

Another purpose of the invention is to provide, such a handle in which the locking/unlocking means are simpler in design and easier to use and install than with existing handles.

Another purpose of the invention is to provide such a handle that is compatible with other traditional equipment on baby carriages, and particularly equipment that can be controlled from these handles.

### SUMMARY OF THE INVENTION

These purposes, and others that will become clearer later, are achieved with the invention, the objective of which is a baby carriage comprising two push arms each with a handle installed free to pivot, the handle comprising means of locking/unlocking in at least two angular positions with respect to the arm and means of actuating the locking/unlocking means, characterized in that the actuation means are free to move along an axis approximately perpendicular to the axis of the push arm.

In this way, the control means can be placed on the handle into a position that makes it possible to access them and manipulate them easily and practically so as to turn the handle with the same hand.

Moreover, the action of these control means in a direction approximately perpendicular to the axis of the push arms makes it possible to use efficient and easy to install locking/unlocking means with a simple design, as will become clearer later.

According to one preferred solution, the handle comprises a terminal gripping part and a connecting part installed free to pivot on the push arm, the actuation means projecting on the connecting part.

With this arrangement, the user can firmly grip the corresponding part of the handle while controlling the actuation means, and consequently it is very practical to turn the handle with a single hand.

According to one advantageous solution, the locking/unlocking means comprise two nested parts extending approximately parallel to the axis of the push arm, a first part being fixed to the push arm and a second part being fixed to the handle, the parts being free to move radially with respect to each other between a locking position in which they are meshed with each other, and an unlocking position in which they are separated.

Advantageously, one of the parts is a fixed part, said to be the passive part, the other part said to be the locking/unlocking part being free to move in the radial direction, the passive part preferably being fixed to the push arm.

Therefore, the result is a solution for locking/unlocking the handle that is mechanically very different to conventional solutions in which the locking/unlocking means move along the axis of the push arm (or parallel to it), for example like dog clutch systems.

In this case, the locking/unlocking part advantageously forms a sheath inside which the passive part is at least partially housed.

The result is a relatively compact and easy to use solution.

According to one preferred solution, the sheath has at least one lock designed to come into contact with at least two complementary housings formed on the passive part at angular intervals, in order to lock the handle in rotation.

Preferably, the lock comprises at least one projection, the passive part having at least two cavities forming a housing for the projection.

Obviously, other embodiments could be envisaged without departing from the scope of the invention, particularly by providing projections on the passive part and forming a locking cavity inside the sheath forming a housing for the projections of the passive part.

Advantageously, the handle has a tubular structure inside which the sheath is installed and in that the tubular structure contains means for guiding the sheath.

Preferably, the handle includes elastic return means tending to bring the locking/unlocking means into the locked position. In this case, the elastic return means are advantageously fitted between the handle and the sheath.

According to another characteristic, the handle includes means of locking the handle in the axial direction with respect to the push arm.

According to one advantageous variant, at least one control cable passes through the handle to lock/unlock folding of the frame.

In this case, the cable controls:

locking/unlocking folding of the frame,

blocking of the front wheels.

The invention also relates to a handle that will be installed free to pivot on a push arm of a baby carriage frame, as described above.

### BRIEF DESCRIPTION OF THE DRAWINGS

Other characteristics and advantages of the invention will become clearer after reading a preferred embodiment of the invention, given as an illustrative and non-limitative example, and the attached drawings among which:

FIG. 1 is a front view of the terminal part of a handle of a baby carriage according to the invention;

FIG. 2 is a view along section BB indicated in FIG. 1;

FIG. 3 is a partial magnification of FIG. 2, at locking/unlocking means and the actuation means;

FIG. 4 is a perspective view of a pivoting handle according to the invention installed on a push arm;

FIG. 5 is a view of a handle according to the invention along section CC indicated in FIG. 4;

FIGS. 6a, 6b, and 6c are diagrammatic representations of a baby carriage as seen from behind, with three distinct positions of the handle.

### DETAILED DESCRIPTION OF THE PREFERRED EMBODIMENTS

As already mentioned above, the general principle of the invention consists of providing locking/unlocking control means for a pivoting handle of a baby carriage that can be moved along an axis perpendicular to the axis of the corresponding push! arm and actuating locking/unlocking means that move and preferably act along the same direction as the control means.

A baby carriage according to the invention comprises a frame with two push arms 1 (FIG. 4), each fitted with a handle 2 at their top end free to pivot about an axis xx′.

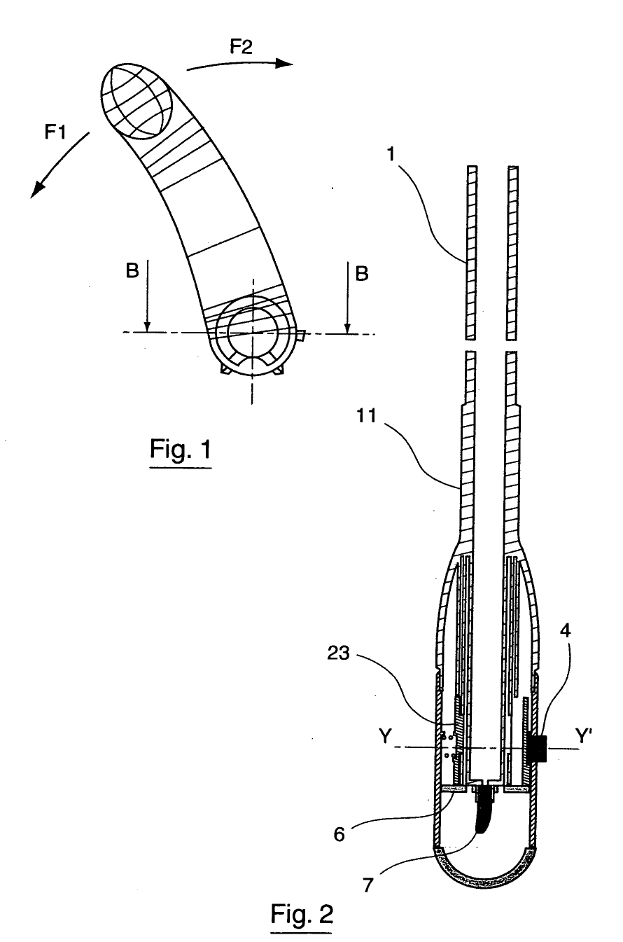

Each handle 2 can thus be pivoted between a position essentially parallel to the main axis of the stroller (position in which the free end of the handles is facing upwards) and a position in which the handles are in a direction pointing towards each other, as indicated by arrows F1 and F2 in FIG. 1, locking/unlocking means being provided to fix the handle in a determined position.

These two distinct handle positions are illustrated by FIGS. 6a and 6b.

The handles are designed to be able to occupy a third position illustrated by FIG. 6c, in which the free hand of the handles is facing downwards. The handles can be placed in this third position, particularly to reduce the size of the baby carriage when it is folded.

Obviously, stable intermediate positions could also be provided.

According to the invention, actuation means 4 are fitted on the handle 2 so as to be moved and to act along the yy′ axis (FIG. 2) perpendicular to the xx′ axis.

According to this embodiment, the handle 2 comprises a connecting part 21 installed free to pivot on the push arm 1, and a terminal gripping part 22.

As can be clearly seen in FIG. 4, the actuation means 4 of the locking/unlocking means consist of a push button projecting from the connecting part 21 of the handle 2.

Furthermore, according to a preferred embodiment of the invention, the push arm is fitted with a so-called passive part 11 about which the handle 2 can pivot, at its end.

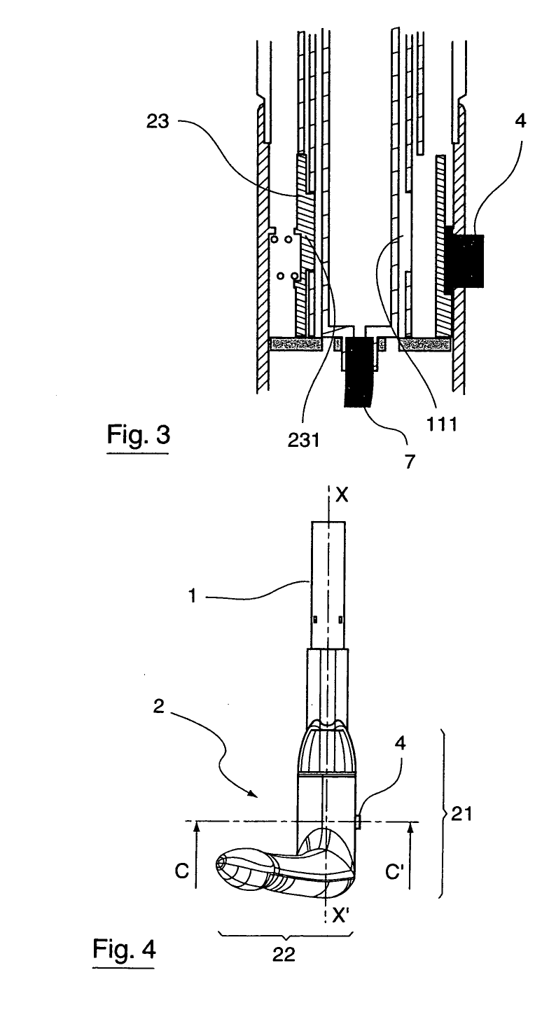

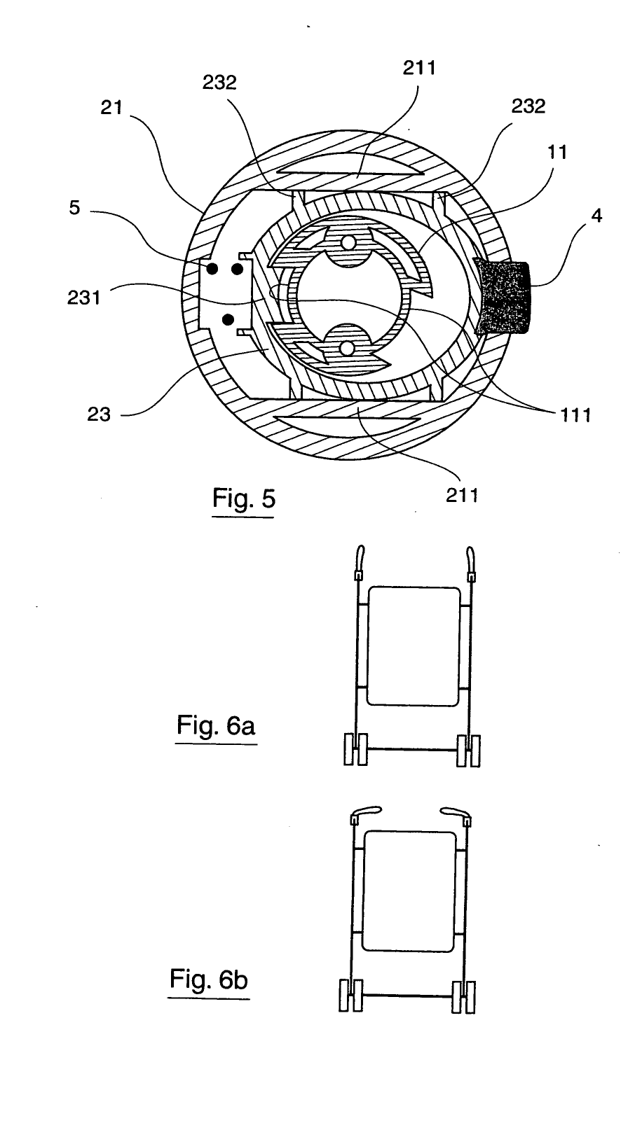

This passive part 11 is provided with two cavities 111 (in the case of two stable positions) forming a housing for a lock that will be described below in more detail with reference to FIGS. 3 and 5.

As can be clearly seen in FIG. 5, the connecting part 21 of the handle 2 has a tubular structure inside which the locking/unlocking means are installed.

These means comprise a sheath 23 inside which the passive part 11 penetrates, this sheath being provided with a lock 231 that will penetrate into cavities 111 in the passive part 11, in order to block rotation of the handle 2 with respect to the corresponding push arm 1.

Furthermore, the tubular structure of the connecting part 21 of the handle 2 integrates guide means for the sheath 23 that is fitted with tabs 232 that can slide on these guide means 211.

With the structure that has just been described, the handle can be unlocked in rotation with respect to the push arm by pressing on the push button 4, which causes the radial displacement of the sheath 23 with respect to the passive part 11, and consequently withdrawal of the lock 231 from one of the cavities 111.

Note that a spring 5 is installed between the sheath 23 and the connecting part 21 of the handle 2, this spring being designed so as to bring the sheath towards or into a locking position, if no action is taken on the push button 4.

Note also that a blocking part 6 is installed in the handle 2 such that the handle is fixed in position with respect to the push arm 1 along its longitudinal axis.

Furthermore, a cable 7 can pass through the handle according to the invention and extend into the axial hole in the passive part 11 and then into the axial hole in the push arm 1, this cable being connected to a control button fitted on the handle 2 to unlock the frame in order to fold it.

Obviously, many variant embodiments could be considered without departing from the scope of the invention. Thus, other locking means could be provided on either part, and could be used for locking in one or several intermediate positions if required.

Although the present invention has been described with reference to preferred embodiments, workers skilled in the art will recognize that changes may be made in form and detail without departing from the spirit and scope of the invention.

What is claimed is:

1. A baby carriage comprising two push arms each with a handle installed free to pivot, the handle comprising means of locking/unlocking in at least two angular positions with respect to the arm and means of actuating the locking/unlocking means,
characterized in that the actuation means are free to move along an axis approximately perpendicular to the axis of the push arm.

2. The baby carriage according to claim 1, characterized in that the handle comprises a terminal gripping part and a connecting part free to pivot on the push arm, the actuation means projecting on the connecting part.

3. The baby carriage according to claim 1, characterized in that the locking/unlocking means comprise two nested parts extending approximately parallel to an axis of the push arm, a first part being fixed to the push arm and a second part being fixed to the handle, the parts being free to move radially with respect to each other between a locking position in which they are meshed with each other, and an unlocking position in which they are separated.

4. The baby carriage according to claim 3, characterized in that one of the parts is a fixed part and the other part is a locking/unlocking part free to move in the radial direction.

5. The baby carriage according to claim 4, characterized in that the fixed part is fixed to the push arm.

6. The baby carriage according to claim 4, characterized in that the locking/unlocking part forms a sheath inside which the fixed part is at least partially housed.

7. The baby carriage according to claim 6, characterized in that the sheath has at least one lock designed to come into contact with at least two complementary housings formed on the passive part at angular intervals, in order to lock the handle in rotation.

8. The baby carriage according to claim 7, characterized in that the lock comprises at least one projection, the fixed part having at least two cavities forming a housing for the projection.

9. The baby carriage according to claim 6, characterized in that the handle has a tubular structure inside which the sheath is installed, the tubular structure containing means for guiding the sheath.

10. The baby carriage according to claim 1, characterized in that the handle includes elastic return means tending to bring the locking/unlocking means into the locked position.

11. The baby carriage according to claim 10, characterized in that the elastic return means are fitted between the handle and the sheath.

12. The baby carriage according to claim 1, characterized in that the handle includes means of locking the handle in the axial direction with respect to the push arm.

13. The baby carriage according to claim 1, characterized in that at least one control cable passes through the handle.

14. The baby carriage according to claim 13, characterized in that the cable controls:
locking/unlocking folding of the frame;
blocking of the front wheels.

15. The baby carriage according to claim 2, characterized in that the locking/unlocking means comprise two nested parts extending approximately parallel to an axis of the push arm, a first part being fixed to the push arm and a second part being fixed to the handle, the parts being free to move radially with respect to each other between a locking position in which they are meshed with each other, and an unlocking position in which they are separated.

16. The baby carriage according to claim 15, characterized in that one of the parts is a fixed part and the other part is a locking/unlocking part free to move in the radial direction.

17. The baby carriage according to claim 16, characterized in that the fixed part is fixed to the push arm.

18. The baby carriage according to claim 17, characterized in that the locking/unlocking part forms a sheath inside which the fixed part is at least partially housed.

19. The baby carriage according to claim 18, characterized in that the sheath has at least one lock designed to come into contact with at least two complementary housings formed on the passive part at angular intervals, in order to lock the handle in rotation.

20. A handle for installation to pivot on a push arm of a baby carriage frame, characterized in that it comprises means of locking/unlocking in at least two angular positions with respect to the push arm and means of actuating the locking/unlocking means, the actuation means being free to move along an axis approximately perpendicular to an axis of the push arm.
